(19) United States
(12) Patent Application Publication
(10) Pub. No.: US 2010/0107426 A1
(43) Pub. Date: May 6, 2010

(54) HAND-HELD HOLE PUNCH

(75) Inventor: Jonathan Newman Cedar, Scarsdale, NY (US)

Correspondence Address: WOLF GREENFIELD & SACKS, P.C., 600 ATLANTIC AVENUE, BOSTON, MA, 02210-2206, US

(73) Assignee: Staples The Office Superstore, LLC, Framingham, MA (US)

(21) Appl. No.: 12/264,344

(22) Filed: Nov. 4, 2008

(51) Int. Cl. B26F 1/32

(52) U.S. Cl. 30/363

(57) ABSTRACT

A hand-held hole punch is provided with a handle assembly including a first handle and a second handle. A first jaw is coupled to the first handle and a second jaw is coupled the second handle, where the second jaw is spaced apart from the first jaw. A punch is coupled to one of the jaws and the handle assembly is adapted to actuate the punch. In one embodiment, the handle assembly actuates the punch by movement of at least one of the first and second handles in manner that maintains a substantially parallel relationship of the second handle with the at least a portion of the first handle. In one embodiment, first and second linkages are provided and movement of one of the handles rotates the first and second linkages.

### FIELD OF INVENTION

The present invention relates to hole punches and more particularly to hand-held hole punches for creating holes through paper.

### BACKGROUND OF INVENTION

Hand-held hole punches are employed to create a hole through one or more sheets of paper. It may be desirable to pierce a hole through paper to allow a user to place the sheets of paper in a ring binder.

A conventional single hole hand-held hole punch 10 is illustrated in FIG. 1. The hole punch 10 includes two handles 12, 14 pivotally connected at pivot point 16. Jaws 18, 20 are integrally formed, respectively, with the handles 12, 14. A punch 22 is located on jaw 18 and a hole (not shown), sized to accommodate the punch 22, is located on the opposite jaw 20. A paper guide 26 is secured to a post 28, which is connected to one of the jaws, and extends through an aperture in the other jaw to permit the jaws to close. A spring (not shown) in the handles 12, 14 may bias the handles 12, 14 apart from one another.

To create a hole using the hole punch 10 of FIG. 1, a user inserts a sheet of paper between the two jaws 1 8 and 20 and rotates the two handles 12, 14 toward one another about pivot point 16. This rotational motion of the handles moves jaw 18 and its punch 22 towards jaw 20 until a hole is pierced through the sheet of paper.

### SUMMARY OF INVENTION

In one aspect of the invention, a hand-held hole punch is disclosed. The hand-held hole punch includes a handle assembly including a first handle and a second handle, where a longitudinal length of at least a substantial portion of the second handle is arranged to be substantially parallel to at least a portion of the first handle. The hole punch further includes a first jaw coupled to the first handle and a second jaw coupled the second handle, where the second jaw is spaced apart from the first jaw. A punch is coupled to the second jaw, and the handle assembly is adapted to actuate the punch, from a rest position to a deployed position, by movement of at least one of the first and second handles in manner that maintains the substantially parallel relationship of the longitudinal length of at least a substantial portion of the second handle with the at least a portion of the first handle.

In another aspect of the invention, a hand-held hole punch is disclosed. The hand-held hole punch includes a handle assembly with a first handle and a second handle, a first jaw coupled to the first handle and a second jaw coupled the second handle, where the second jaw is spaced apart from the first jaw. The hole punch further includes a first linkage pivotally coupled to the second handle and coupled to the second jaw, and a second linkage pivotally coupled to both the first handle and the second handle. A punch is coupled to at least one of the first jaw and the second jaw, and the handle assembly is adapted to actuate the punch, from a rest position to a deployed position, by movement of at least one of the first and second handles in a manner that rotates the first and second linkages.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a side view of a conventional single hole hand-held hole punch;

FIG. 2 is a rear perspective view of an illustrative embodiment of a hand-held hole punch;

FIG. 3 is a side view of the hole punch of FIG. 2 shown in a pre-actuation position;

FIG. 4 is a side view of the hole punch of FIG. 2 shown in a punch position;

FIG. 5 is an exploded assembly view of the hole punch of FIG. 2;

FIG. 6 is a perspective view of a partially assembled hole punch;

FIG. 7 is another perspective view of a partially assembled hole punch;

FIG. 8 is a side view of the hole punch of FIG. 2 shown with the chad chamber in a closed position; and

FIG. 9 is a side view of the hole punch of FIG. 2 shown with the chad chamber in an open position.

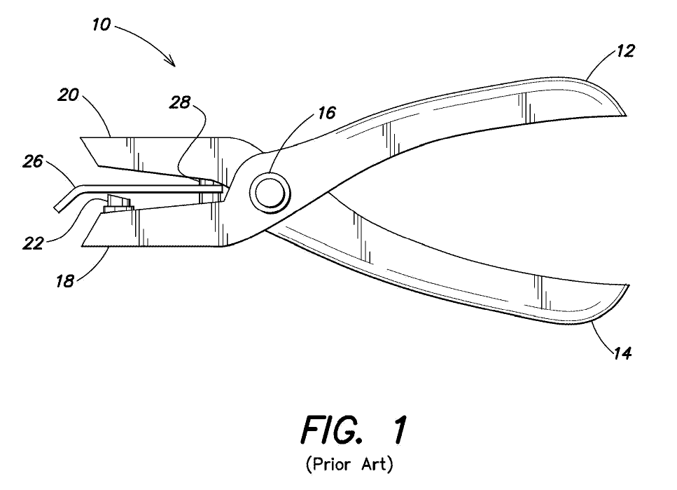

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving,” and variations thereof herein, is meant to encompass the items listed thereafter and equivalents thereof as well as additional items.

Aspects of the invention are directed to a hand-held hole punch used to create holes through material, such as, but not limited to, one or more sheets of paper. The holes may be pierced in the paper to allow a user to place the sheets of paper in a ring binder. The hand-held hole punch includes a handle assembly having a first handle and a second handle with a first jaw coupled to the first handle and a second jaw coupled to the second handle. A punch configured to pierce holes into the paper is coupled to one of the jaws and the handle assembly is configured to actuate the punch. It should be appreciated that the hole punch may also be configured to create holes through non-paper material, as the invention is not so limited.

Certain embodiments of the present invention are directed to a hand-held hole punch having a handle assembly which is configured to make it easier for a user to actuate the punch. As discussed in greater detail below, the handle assembly may be configured to actuate the punch by substantially linear movement (i.e. non-rotational movement) of a portion of the handle assembly. The handle assembly may be configured to actuate the punch by movement of a portion of the handle assembly in a direction such that it maintains a substantially parallel relationship with another portion of the handle assembly.

Other embodiments of the present invention are directed to a hand-held hole punch with a linkage assembly including a first linkage and a second linkage. In one embodiment, the first linkage is pivotally coupled to the first handle, and the second linkage is pivotally coupled to both the first handle and the second handle.

Turning now to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

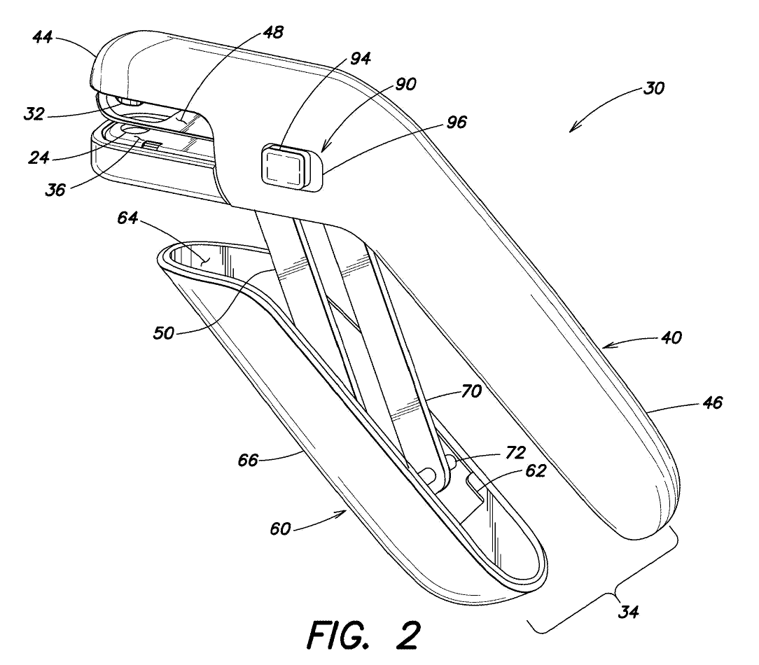

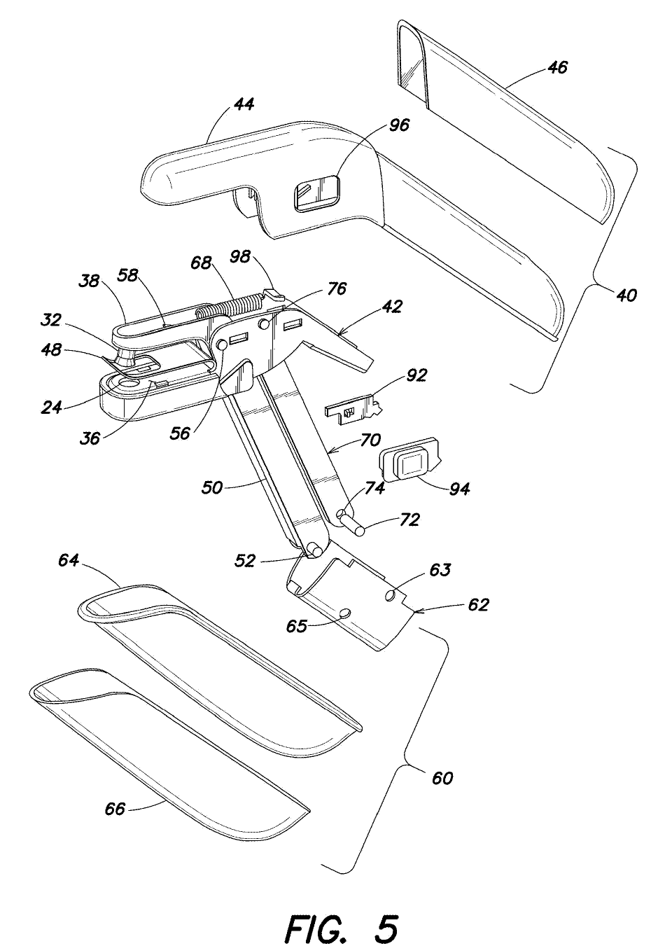

In FIGS. 2-9, a hole punch 30 is illustrated. The hole punch 30 includes a first jaw 36 and a second jaw 38 spaced apart from the first jaw 36. At least one punch 32 is coupled to one of the jaws 36, 38 (see FIG. 5) and is configured to pierce a hole through one or more sheets of paper when the paper (not shown) is inserted between the jaws 36, 38. In one illustrative embodiment, the punch 32 is a rounded protrusion that extends outwardly from the second jaw 38 (see FIG. 5). The punch 32 may have sharp edges configured to cut through the paper to create a hole in the paper.

The first jaw 36 is spaced apart from and positioned opposite the punch 32 and may include an opening 24 sized to receive the punch 32. In one illustrative embodiment, the first jaw 36 has an opening 24 arranged such that the punch 32 can extend into the opening 24 after the hole is created through the paper. The hole punch 30 may also include a paper guide 48 positioned in between the jaws 36, 38. The paper guide 48 may be used to hold the paper and separate the paper from the punch 32 after the punch 32 creates a hole through the paper. As shown, the guide 48 may include an opening aligned with the opening 24 in the first jaw 36 so that the punch 32 can pass through the guide 48.

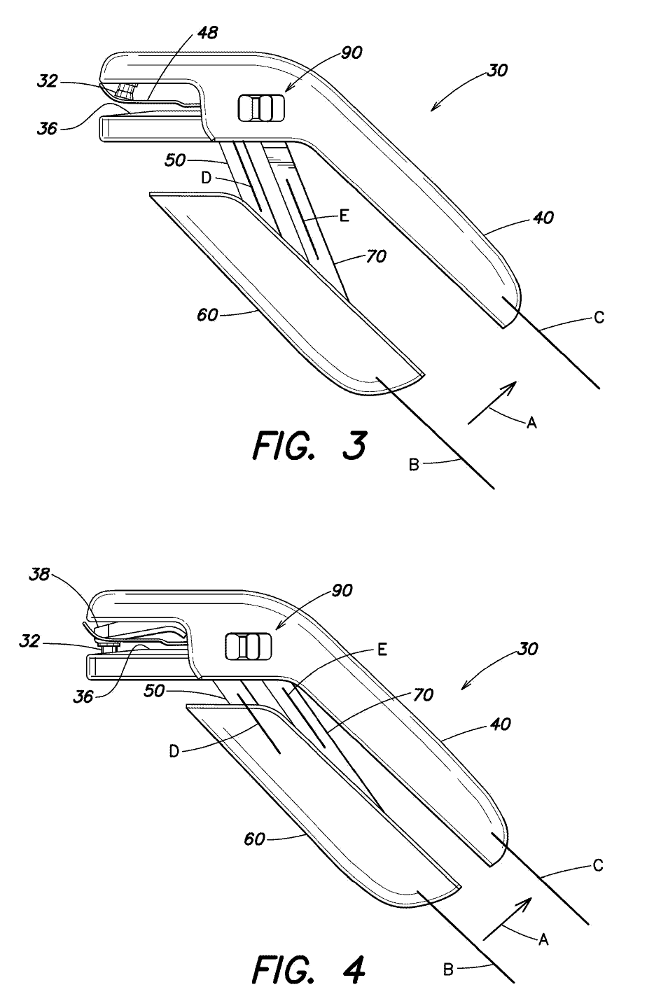

A handle assembly 34, including a first handle 40 and a second handle 60, is configured to actuate the punch 32. Upon actuation of the handle assembly 34, the punch 32 moves from a rest position (shown in FIG. 3) towards the first jaw 36 and to a deployed position (shown in FIG. 4). As discussed in greater detail below, the handle assembly 34 may be configured to actuate the punch 32 by movement of at least one of the handles 40, 60 closer to the other handle. The punch 32 is configured to create a hole through a sheet of paper when the punch 32 is in its deployed position.

As shown in FIG. 3, in one embodiment, a longitudinal length of the second handle 60 (defined by line B) is substantially parallel to at least a portion of the first handle 40 (defined by line C) in the pre-actuation position, and as shown in FIG. 4, in one embodiment, the longitudinal length of the second handle 60 (defined by line B) is substantially parallel to at least a portion of the first handle 40 (defined by line C) in the punch position. As discussed in greater detail below, in one embodiment, the second handle 60 is constructed to move in a linear fashion (in the direction of arrow A) to maintain a substantially parallel relationship between the longitudinal length of the second handle 60 and the first handle 40.

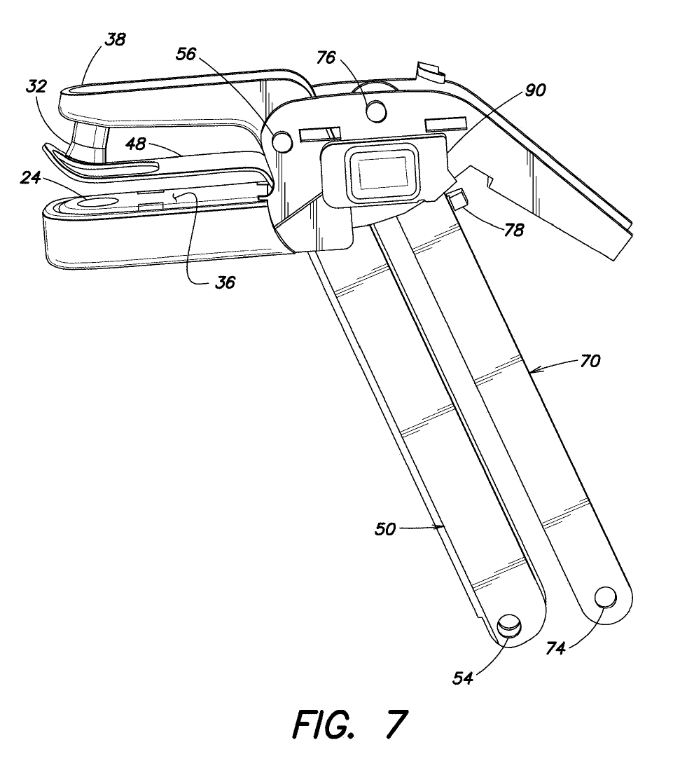

In one embodiment, the handle assembly 34 includes a first linkage 50 pivotally coupled to the second handle 60. As shown in FIG. 5, a first end of the first linkage 50 may be pivotally coupled to the second handle 60 at pin 52. The second handle 60 may include a handle inner component 62 configured to hold the pin 52. In one illustrative embodiment, the handle inner component 62 has a hole 64 sized to receive the pin 52. As shown in FIG. 7, the first end of the first linkage 50 may also have a hole 54 sized to receive the pin 52.

The first linkage 50 may be coupled to the second jaw 38 and may be movable therewith. In one embodiment, the first linkage 50 may be pivotally coupled to the second handle 60 and the second end of the first linkage 50 may be coupled to the second jaw 38 such that movement of the second handle 60 moves the second jaw 38 and the punch 32 downwardly into its deployed position. As shown in FIG. 7, in one embodiment, the first linkage 50 is integrally formed with the second jaw 38. It should be appreciated that in other embodiments, the first linkage 50 may be coupled to, but not integral with, the second jaw 38, as the invention is not so limited.

In one illustrative embodiment, the first linkage 50 is pivotally coupled to the first handle 60. As shown in FIGS. 5-7, the second end of the first linkage 50 may be pivotally coupled to the first handle 40 at pin 56. The first handle 40 may include a handle inner component 42 configured to hold the pin 56 and the first linkage may have a hole sized to receive the pin 56.

It should further be recognized that in other embodiments, the first linkage 50 may be coupled to the first handle 40, the second handle 60 and/or the second jaw 38 differently as the invention is not limited in this respect.

In one embodiment, the handle assembly includes a second linkage 70 pivotally coupled to both the first and second handles 40, 60. As shown in FIG. 5, a first end of the second linkage 70 may be pivotally coupled to the second handle 60 at pin 72. The handle inner component 62 may be configured to hold the pin 72, and in one embodiment, the handle inner component 62 has a hole 63 sized to receive the pin. As shown in FIGS. 5 and 7, the first end of the second linkage 70 may also have a hole 74 sized to receive the pin 72.

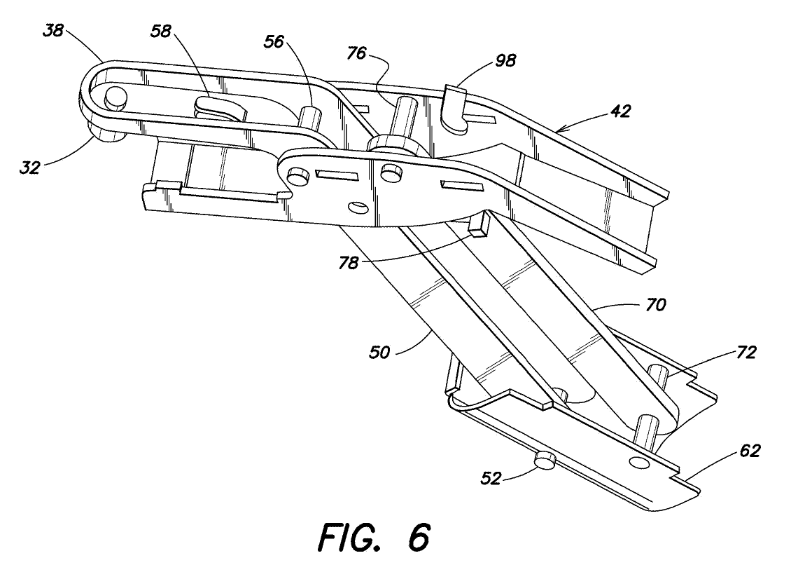

The second end of the second linkage 70 may be pivotally coupled to the first handle 40 at pin 76. Similar to the second handle 60, the first handle 40 may also include a handle inner component 42 configured to hold the pin 76. In one illustrative embodiment, the handle inner component 42 has a hole sized to receive the pin 76. As shown in FIG. 6, in one embodiment, the second end of the second linkage 70 may also have a hole sized to receive the pin 76.

It should be appreciated that in other embodiments, the second linkage 70 may be coupled to the first and second handles 40, 60 differently, as the invention is not limited in this respect.

In one embodiment, linear movement of the second handle 60 relative to the first handle 40 actuates the punch 32. In one illustrative embodiment, movement of the second handle 60 in a manner that maintains the substantially parallel relationship of the longitudinal length of a substantial portion of the second handle 60 with at least a portion of the first handle 40 actuates the first linkage 50 which moves the punch 32. As shown in FIGS. 3 and 4, linear movement of the second handle 60 in the direction of arrow A towards the first handle 40 rotates the first linkage 50 and second jaw 3 8 in a counter-clockwise direction which pivotally moves the punch 32 into its deployed position.

In this regard, upon pressing the second handle 60 toward the first handle 40 in the direction of arrow A (see FIGS. 3 and 4) the first linkage 50 rotates about an axis defined by pin 56 (see FIGS. 6 and 7). When the first linkage 50 is movable with the second jaw 38, this rotational movement of the first linkage 50 rotates the second jaw 38 and punch 32 down towards the first jaw 36. In this respect, the punch 32 pivotally moves from the rest position to the deployed position. Because the second linkage 70 is pivotally coupled to the second handle 60, the movement of the second handle 60 towards the first handle 40 also rotates the second linkage 70 in a counter-clockwise direction. In one embodiment, the second linkage 70 rotates about an axis defined by pin 76 (see FIGS. 6 and 7). As a result, the first and second linkages 50, 70 move from the pre-actuation position of FIG. 3 to the punch position shown in FIG. 4.

As shown in FIG. 5, the handle assembly 34 may include a spring 68 to bias the handle assembly 34 in the pre-actuation position such that the handle assembly 34 will automatically return to the pre-actuation position after the punch 32 is actuated into its deployed position. As illustrated in FIGS. 5 and 6, in one embodiment, the spring 68 may be coupled at one end to the second jaw 3 8 at hook 58 and at the other end, the spring 68 may be coupled to the first handle inner component 42 at hook 98. In one embodiment, the spring 68 may be a helical spring. In one embodiment, the spring 68 may wrap around a pivot point such as pin 76. It should be appreciated that in other embodiments, the spring 68 may be coupled to the handle assembly 34 differently and/or the handle assembly may be biased differently, as the invention is not so limited.

The hole punch 30 may be configured such that the first linkage 50 is substantially parallel to the second linkage 70 when the handle assembly 34 is in the pre-actuation position. For example, as shown in FIG. 3, line D extends along the longitudinal length of the first linkage 50 and line E extends along the longitudinal length of the second linkage 70 to more clearly illustrate the substantially parallel relationship between the first and second linkages 50, 70 in the pre-actuation position.

As shown in the embodiment illustrated in FIG. 4, the hole punch 30 may be configured such that the first linkage 50 is substantially parallel to the second linkage 70 when the handle assembly 34 is in the punch position. In particular, line D which extends along the longitudinal length of the first linkage 50 is substantially parallel to line E which extends along the longitudinal length of the second linkage 70 when the handle assembly 34 is in the punch position. Furthermore, in one embodiment, the parallel relationship between the first and second linkages 50, 70 may be maintained between the pre-actuation position and the punch position.

As shown in the exploded assembly view of FIG. 5, in one embodiment, the second handle 60 includes a plurality of components. In one embodiment, the second handle 60 includes the above-mentioned handle inner component 62 which couples the first and second linkages 50, 70 to the second handle 60 through pins 52, 72. As shown, the second handle 60 may also include a handle cover 64 and a handle shell 66. In one embodiment, the handle cover 64 receives and retains the handle inner component 62 and the handle cover 64 may increase the overall size of the second handle 60 which may make it easier for a user to grip. The handle cover 64 may also be received and retained within the handle cover 66 which may be provided with desirable surface gripping characteristics. In one embodiment, the handle cover 66 may be formed of a higher friction material, such as a thermal plastic clastomer (TPE) to assist a user in gripping the handle 60 to actuate the handle assembly 34. As shown in FIGS. 3 and 4, in one embodiment, the handle cover 64 and/or handle shell 66 may at least partially enclose at least a portion of the first linkage 50 and/or second linkage 70. As illustrated, in one embodiment, one or more of the components of the second handle 60 may be provided in a nesting arrangement. However, it should be appreciated that in other embodiments, the second handle 60 may be configured differently, as the invention is not so limited. As also shown in the exploded view of FIG. 5, in one embodiment, the first handle 40 includes a plurality of components. In one embodiment, the first handle 40 includes the above-mentioned handle inner component 42 which couples the first and/or second linkages 50, 70 to the first handle 40 through pins 56, 76. As shown in FIG. 5, the first handle 40 may also include a handle cover 44 and a handle shell 46. In one embodiment, the handle cover 44 receives and retains the handle inner component 42 and the handle cover 44 may increase the overall size of the first handle 40 which may make it easier for a user to grip. The handle cover 44 may also be received and retained within the handle cover 46 which may be provided with desirable surface gripping characteristics. In one embodiment, the handle cover 46 may be formed of a higher friction material, such as a thermal plastic elastomer (TPE) to assist a user in gripping the handle 40 to actuate the handle assembly 34. In one embodiment, the handle cover 44 and/or handle shell 46 may extend up to and at least partially enclose at least a portion of the second jaw 38. As shown in FIG. 3, in one embodiment, the handle cover 44 at least partially encloses the second jaw 38 when the handle assembly 34 is in the pre-actuation position. As illustrated, in one embodiment, one or more of the components of the first handle 40 may be provided in a nesting arrangement. However, it should be appreciated that in other embodiments, the first handle 40 may be configured differently, as the invention is not so limited.

In one embodiment, the hole punch 30 is configured to collapse into a stowed configuration in which the hole punch takes up a smaller size than it does in its pre-actuation position shown in FIG. 3. At least a portion of the handle assembly 34 may collapse to reduce the overall volume of the hole punch when the hole punch 30 is in its stowed configuration. In one embodiment, the stowed configuration is similar to the punch position shown in FIG. 4, and the first linkage 50 is adapted to be recessed into the second handle 60. As shown, the two handles 40, 60 may be spaced apart when the hole punch 30 is in the stowed configuration. It should be appreciated that in another embodiment, the hole punch 30 may be configured such that the two handles 40, 60 contact each other in a stowed configuration, as the invention is not so limited.

According to one embodiment of the invention, the hole punch 30 includes a lock 90 to hold the position of the linkages 50, 70 in the stowed configuration. The stowed configuration may be when the handle assembly 34 is in either the pre-actuation position, in the punch position, or in a position between the pre-actuation position and the punch position, as the present invention is not limited in this respect. In one embodiment, the stowed configuration is in the punch position shown in FIG. 4.

In one embodiment, the lock 90 is disposed on the handle assembly 34 and in particular, on the first handle 40. The lock 90 includes a detent 92 that engages with the handle assembly 34 to prevent movement of the linkages 50, 70. As shown in FIGS. 2-5, to move the lock 90 to the locked position where the detent 92 is engaged with a hook 78 on the second linkage 78 (see FIGS. 6-7) and to an unlocked position where the detent is disengaged from the hook 78, a slide member 94 is attached to the detent 92. When assembled, the slide member 94 may be positioned within a recess 96 formed in the first handle 40 so as to maintain a low profile design. In one embodiment, the detent 92 may be configured to engage with at least one of the first and second linkages 50, 70. As shown in greater detail in FIGS. 6-7, the lock 90 is selectively engageable with a hook 78 which extends outwardly from the second linkage 70. It should be appreciated that in another embodiment, the lock 90 may be configured differently, as the invention is not so limited.

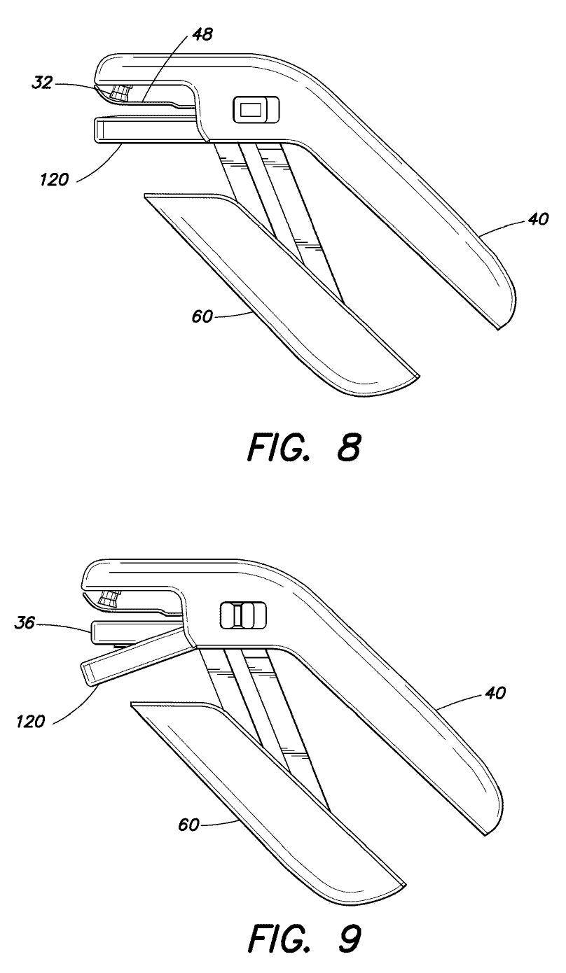

The hole punch 30 may include features to capture the resulting punched paper from the hole after a sheet of paper has been created. These resulting chads may be held within a chamber 120 disposed below one of the jaws 36, 38. In one embodiment, as shown in FIGS. 8 and 9, this chamber 120 may be formed below the first jaw 36. As shown in FIG. 9, the chamber 120 may be pivotally coupled to the first jaw 36 to provide access to the inside of the chamber 120.

Although a chamber 120 is employed, the present invention is not limited in this regard, as other suitable receptacles may be employed. In addition, no chamber need be employed and the chads may simply be expelled from the hole punch 30.

As can be appreciated, the hole punch may be formed of any suitable material, as the present invention is not limited in this regard. Similarly, the hole punch may be sized to accommodate any number of sheets including one, five, ten, twenty, forty or more sheets. In one embodiment, the jaws 36,38, linkages 50, 70 and punch 32 are formed of metal. Other non-structural components may be formed of a lower strength material, such as plastic. As mentioned above, some components of the hole punch 30, such as portions of the handle assembly 34, may be formed of thermal plastic elastomer (TPE).

The punch 32 may be formed of any suitable materials as the present invention is not limited in this regard. In one embodiment, the punch 32 is at least partially formed of a low friction material, thereby allowing for further ease of entry of the sheet material. In one embodiment, the punch is formed of a metallic material that may be coated with a low friction material. In still other embodiments, the punch may be formed of a durable plastic material. Combinations of materials are also contemplated, as the present invention is not limited in this respect.

As is conventional, the punch 32 is formed so as to produce a circular hole. However, the shape of the cutting end may be any desired shape, as the present invention is not limited in this regard. For example, the cutting end may have a cross section in the shape of a polygon, such as, a square, a rectangle, or a triangle, or other shapes, such as an oval, a star, or a heart. Other desired shapes may be employed.

The foregoing written specification is to be considered to be sufficient to enable one skilled in the art to practice the invention. While the best mode for carrying out the invention has been described in detail, those skilled in the art to which this invention relates will recognize various alternative embodiments including those mentioned above as defined by the following claims. The examples disclosed herein are not to be construed as limiting of the invention as they are intended merely as illustrative of particular embodiments of the invention as enabled herein. Therefore, systems and methods that are functionally equivalent to those described herein are within the spirit and scope of the claims appended hereto. Indeed, various modifications of the invention in addition to those shown and described herein will become apparent to those skilled in the art from the foregoing description and fall within the scope of the appended claims.

What is claimed is:

1. A hand-held hole punch, comprising:
a handle assembly including a first handle and a second handle, wherein a longitudinal length of at least a substantial portion of the second handle is constructed and arranged to be substantially parallel to at least a portion of the first handle;
a first jaw coupled to the first handle;
a second jaw coupled the second handle, wherein the second jaw is spaced apart from the first jaw;
a punch coupled to the second jaw, wherein the handle assembly is adapted to actuate the punch, from a rest position to a deployed position, by movement of at least one of the first and second handles in manner that maintains the substantially parallel relationship of the longitudinal length of at least a portion of the second handle with the at least a portion of the first handle.

2. The hand-held punch of claim 1, wherein the handle assembly is adapted to actuate the punch by movement of the second handle towards the first handle.

3. The hand-held punch of claim 1, further comprising:
a first linkage pivotally coupled to the second handle and coupled to the second jaw.

4. The hand-held punch of claim 3, wherein the first linkage is integrally formed with the second jaw.

5. The hand-held punch of claim 3, wherein the first linkage is pivotally coupled to the first handle.

6. The hand-held punch of claim 3, further comprising:
a second linkage pivotally coupled to both the first handle and the second handle.

7. The hand-held punch of claim 1, further comprising:
a chamber coupled to the first jaw to capture a resulting chad after paper is punched.

8. The hand-held punch of claim 7, wherein the chamber is pivotally coupled to the first jaw to provide access to the inside of the chamber.

9. The hand-held hole punch of claim 1, wherein the handle assembly is movable from a pre-actuation position to a punch position, and wherein the hole punch further comprises a lock constructed and arranged to hold the handle assembly in a stowed configuration located at or between the pre-actuation position and the punch position.

10. The hand-held hole punch of claim 9, wherein the lock is constructed and arranged to hold the handle assembly in the punch position.

11. The hand-held hole punch of claim 6, wherein the handle assembly is movable from a pre-actuation position to a punch position, wherein the hole punch further comprises a lock constructed and arranged to hold the handle assembly in a stowed configuration located at or between the pre-actuation position and the punch position, and wherein the lock includes a detent constructed and arranged to be selectively engageable with at least one of the first and second linkages.

12. The hand-held hole punch of claim 1, wherein the first handle extends up to and at least partially encloses the second jaw when the handle assembly is in a pre-actuation position.

13. The hand-held hole punch of claim 1, wherein the punch pivotally moves from the rest position to the deployed position.

14. The hand-held hole punch of claim 6, wherein the handle assembly is movable from a pre-actuation position to a punch position, and wherein the first linkage is substantially parallel to the second linkage in the pre-actuation position.

15. The hand-held hole punch of claim 14, wherein the first linkage is substantially parallel to the second linkage in the punch position.

16. A hand-held hole punch, comprising:
a handle assembly including a first handle and a second handle;
a first jaw coupled to the first handle;
a second jaw coupled the second handle, wherein the second jaw is spaced apart from the first jaw;
a first linkage pivotally coupled to the second handle and coupled to the second jaw;
a second linkage pivotally coupled to both the first handle and the second handle; and
a punch coupled to at least one of the first jaw and the second jaw, wherein the handle assembly is adapted to actuate the punch, from a rest position to a deployed position, by movement of at least one of the first and second handles in a manner that rotates the first and second linkages.

17. The hand-held punch of claim 16, wherein the punch is coupled to the second jaw.

18. The hand-held punch of claim 16, wherein the handle assembly is adapted to actuate the punch by movement of the second handle towards the first handle.

19. The hand-held hole punch of claim 16, wherein a longitudinal length of at least a substantial portion of the second handle is constructed and arranged to be substantially parallel to at least a portion of the first handle, and wherein the handle assembly is adapted to actuate the punch by movement of at least one of the first and second handles in manner that maintains the substantially parallel relationship of the longitudinal length of at least a substantial portion of the second handle with the at least a portion of the first handle.

20. The hand-held hole punch of claim 16, wherein the first linkage is integrally formed with the second jaw.

21. The hand-held punch of claim 16, wherein the first linkage is pivotally coupled to the first handle.

22. The hand-held hole punch of claim 16, wherein the handle assembly is movable from a pre-actuation position to a punch position, and wherein the hole punch further comprises a lock constructed and arranged to hold the handle assembly in a stowed configuration located at or between the pre-actuation position and the punch position.

23. The hand-held hole punch of claim 22, wherein the lock is constructed and arranged to hold the handle assembly in the punch position.

24. The hand-held hole punch of claim 16, wherein the handle assembly is movable from a pre-actuation position to a punch position, and wherein the first linkage is substantially parallel to the second linkage in the pre-actuation position.

25. The hand-held hole punch of claim 24, wherein the first linkage is substantially parallel to the second linkage in the punch position.
